(19) United States
(12) Patent Application Publication
(10) Pub. No.: US 2016/0192121 A1
(43) Pub. Date: Jun. 30, 2016

(54) METHODS AND SYSTEMS FOR SHARING CONTACT INFORMATION BETWEEN MOBILE DEVICES

(71) Applicant: Humin, Inc., San Francisco, CA (US)

(72) Inventors: Ankur JAIN, San Francisco, CA (US); Ian MURRAY, San Francisco, CA (US); Daniel O'SHEA, San Francisco, CA (US); Kevin LINDKVIST, San Francisco, CA (US); Joe DAO, San Francisco, CA (US); Clara ZAVANI, San Francisco, CA (US); Ryan MICK, San Francisco, CA (US); John ULLMAN, San Francisco, CA (US); Arielle ZUCKERBERG, San Francisco, CA (US); Mijail GOMEZ, San Francisco, CA (US); James MCERLAIN, San Francisco, CA (US); Sinan ARAL, San Francisco, CA (US); Purshotam RAJANI, San Francisco, CA (US); David WYLER, The Hague (NL)

(21) Appl. No.: 14/883,434

(22) Filed: Oct. 14, 2015

Related U.S. Application Data
(60) Provisional application No. 62/063,890, filed on Oct. 14, 2014.

(51) Int. Cl. H04W 4/00; G06Q 50/00; G06Q 10/10; H04W 76/02; H04L 29/08

(52) U.S. Cl. CPC H04W 4/008; H04W 76/023; H04L 67/2814; G06Q 10/10; G06Q 50/01

(57) ABSTRACT

The present disclosure provides a method for exchanging contact information, comprising detecting a first exchange event on a first mobile electronic device of a first user and initiating the exchange of contact information between the first mobile electronic device and a second mobile electronic device of another user that has detected a second exchange event. Next, contact information of the first user is transmitted from the first mobile electronic device to the second mobile electronic device and contact information of the second user is received at the first mobile electronic device.

### CROSS-REFERENCE

This application claims priority to U.S. Provisional Patent Application No. 62/063,890, filed Oct. 14, 2014, which is entirely incorporated herein by reference.

### BACKGROUND

A user can have and maintain a database of contacts with contact information relating to persons or entities that the user knows or wishes to know. Such database can be maintained on a server and/or a mobile electronic device of the user.

There are various services and applications available that enable a user to maintain a database of contacts, which may include users and entities (e.g., companies) that the user knows or may know. LinkedIn®, for instance, allows registered users to maintain a list of contact details of people with whom they are linked to, called “connections.” A user may search for other users, and once another user is found, that user may be added to a contact database (e.g., contact list) of the user that initiated the search.

### SUMMARY

The proliferation and diversity of mobile electronic devices (also “mobile devices” herein) as well as social media and chat handles has made it increasingly cumbersome to exchange contact information with other users. In some situations, users can exchange contact information by email or text message, which can be transmitted from one mobile device to another, but this is relatively time consuming. Accordingly, recognized herein is the need for improved methods of exchanging diverse contact information between users of mobile electronic devices.

Using methods and systems described herein, users may exchange information, such as contact information, photos, and social media handles, by initiating an exchange event. The exchange event may allow a user to exchange information with another user or with a plurality of other users. In this way, a user may benefit from providing and exchanging information to a group of people in an efficient manner. For example, if a user is at a business networking event, the user may provide selected information to the group of people at the event.

In additional examples, a user may tailor the information that is provided to individuals. In this way, the user may benefit from the ability to opt-in or opt-out of different types of information that may be shared with others. In this way, the user may keep control of his privacy with respect to different individuals. Further, a user may use methods and systems describe herein to search for other users who may be within a geographic proximity of the user. Based on this information, the user may choose to share information with users that are discovered within the geographic proximity. This may benefit users who are looking to interact with others having similar backgrounds, interests, or other shared traits.

Many mobile communication devices, such as mobile phones, smart phones, personal computers (“PCs”), and other network-enabled devices, allow users to exchange their contact information when they meet one another. The exchange can be performed in a variety of ways. For example, users can exchange contact information with their mobile communication devices over a short-range communication link, such as Near-field Communication (NFC) or Low Energy Bluetooth (BLE), which allows wireless communication over a relatively short distance, ranging from a few centimeters to several meters.

The present disclosure provides systems and methods that enable a user to maintain a consolidated database (e.g., list) of contacts in a single location, such as a mobile device of the user, and to readily exchange contact information (e.g., name, address, telephone number, email address, and/or social media handles) with a mobile device of another user. The exchange of such contact information can be coupled with the collection of contextual information about an environment at or in proximity to the mobile device of the user, such as geographic location, nearby businesses, co-located events or venues, and weather information. Additionally, the exchange of contact information may be coupled with the electronic discovery of nearby users. In examples, a user may be notified when other users are present. Once a user knows that other users are present, the user may exchange pertinent identifying information with one or more of the other users.

An aspect of the present disclosure provides a method for contact management, comprising (a) detecting a first exchange event on a first mobile electronic device of a first user, wherein the first exchange event is indicative of willingness of the first user to share a first contact information with one or more other users; (b) initiating exchange of contact information between the first mobile electronic device and a second mobile electronic device of another user, wherein the second mobile electronic device has detected a second exchange event on the second mobile electronic device by the second user, wherein the second exchange event is indicative of willingness of the second user to share a second contact information with one or more other users; (c) transmitting the first contact information from the first mobile electronic device to the second mobile electronic device; and (d) receiving the second contact information of the second user at the first mobile electronic device.

In some embodiments, each of the first or second exchange event comprises a series of two or more taps on the first mobile electronic device and/or the second mobile electronic device. In some embodiments, the first contact information is transmitted to the second mobile electronic device through a computer server. In some embodiments, the method further comprises receiving a notification of the one or more other users at or in proximity to the first mobile electronic device of the first user. In some embodiments, the one or more other users comprise a plurality of users.

In some embodiments, each user of the plurality of users is within a threshold geographic distance from the first mobile electronic device of the first user. Additionally, in some embodiments, the method further comprises initiating exchange of contact information between the first mobile electronic device and mobile electronic devices of the plurality of users, wherein each mobile electronic device of the plurality of mobile electronic devices has detected an exchange event on the mobile electronic device by a user of the plurality of users that is indicative of willingness of the user to share contact information with at least the first user. In some embodiments, the method further comprises transmitting the first contact information from the first mobile electronic device to the plurality of mobile electronic devices.

In some embodiments, the method further comprises receiving the contact information of the plurality of users at the first mobile electronic device. In some embodiments, the method further comprises determining a relational strength between the first user and at least one user of the one or more other users. In some embodiments, the first contact information and the second contact information contain at least one shared type of contact information. In some embodiments, the first contact information and the second contact information contain different types of contact information. In some embodiments, the method further comprises transmitting additional information from the first mobile electronic device to the second mobile electronic device. In some embodiments, the additional information comprises at least one of location information and photo information.

Another aspect of the present disclosure provides a system for contact management, comprising a communications interface that brings a first mobile electronic device of a first user in communication with a second mobile electronic device of a second user; and one or more computer processors operatively coupled to the communications interface, wherein the one or more computer processors are programmed to (a) detect a first exchange event on a first mobile electronic device of a first user, wherein the first exchange event is indicative of willingness of the first user to share a first contact information with one or more other users; (b) initiate exchange of contact information between the first mobile electronic device and a second mobile electronic device of another user, wherein the second mobile electronic device has detected a second exchange event on the second mobile electronic device by the second user, wherein the second exchange event is indicative of willingness of the second user to share a second contact information with one or more other users; (c) transmit the first contact information from the first mobile electronic device to the second mobile electronic device; and (d) receive the second contact information of the second user at the first mobile electronic device.

A further aspect of the present disclosure provides a non-transitory computer readable medium comprising machine-executable code that, upon execution by one or more computer processors, implements a method for contact management, the method comprising: (a) detecting a first exchange event on a first mobile electronic device of a first user, wherein the first exchange event is indicative of willingness of the first user to share a first contact information with one or more other users; (b) initiating exchange of contact information between the first mobile electronic device and a second mobile electronic device of another user, wherein the second mobile electronic device has detected a second exchange event on the second mobile electronic device by the second user, wherein the second exchange event is indicative of willingness of the second user to share a second contact information with one or more other users; (c) transmitting the first contact information from the first mobile electronic device to the second mobile electronic device; and (d) receiving the second contact information of the second user at the first mobile electronic device.

In some embodiments, the one or more computer processors are programmed to transmit additional information from the first mobile electronic device to the second mobile electronic device. In some embodiments, the additional information comprises at least one of location information and photo information. In some embodiments, the one or more computer processors are programmed to initiate the exchange of contact information between the first mobile electronic device and a plurality of mobile electronic devices that are each associated with an unique user. In some embodiments, the one or more computer processors are programmed to receive a notification of the one or more other users, which one or more other users are at or in proximity to the first mobile electronic device of the first user. In some additional embodiments, the one or more computer processors are programmed to determine a relational strength between the first user and at least one user of the one or more other users.

Another aspect of the present disclosure provides a computer readable medium with machine executable code that upon execution by one or more computer processors implements any of the methods above or elsewhere herein.

Another aspect of the present disclosure provides a computer system (e.g., a mobile device) comprising one or more computer processors and computer memory. The computer memory comprises machine executable code that upon execution by the one or more computer processors implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a system having three mobile electronic devices;

FIG. 2A schematically illustrates the exchange of contact information between mobile devices directly; FIG. 2B schematically illustrates the exchange of contact information between mobile devices indirectly through a computer server;

FIG. 3A shows a user interface displaying nearby users detected by an application; FIG. 3B shows a user interface displaying biographical details for a selected nearby user;

FIG. 4 shows a user interface for the comprehensive contact profile of another user;

FIG. 5 shows a user interface for sharing contact information and social media handles;

FIG. 6 shows a user interface for opening third party messaging and social media apps from a comprehensive contact profile;

FIG. 7 shows a user interface for selecting contacts to include in a group-messaging or exchange event;

FIG. 8A shows a user interface detailing exchange and group-messaging event history; FIG. 8B shows a user interface for interacting with and managing events from the event history;

FIG. 9 shows a user interface for a multi-functional group-messaging platform;

FIG. 10 shows an algorithm to determine whether or not the device should engage active monitoring of device sensors to detect haptic input;

FIG. 11 shows an algorithm to pattern-match specific haptic input sequences to trigger system features; and

FIG. 12 schematically shows a computer system that is programmed or otherwise configured to implement methods of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “contact,” as used herein, generally refers to an individual or entity (e.g., organization or company) that has contact information as well as other attributes, such as, without limitation, tie strength(s) and strong mutual connection(s).

The term “secondary contact,” as used herein, generally refers to a contact of a contact of a user.

The term “contact information,” as used herein, generally refers to any identifying information of a user or entity, such as, without limitation, name, telephone (“phone”) number, electronic mail (“email”) address, social network identification (“social network ID”), and/or instant messaging (“IM”) handle.

The term “identity,” as used herein, generally refers to any uniquely identifying information of or related to a user or contact of a user, such as one or more of name (first and/or last name), address (street address, city, state, zip code), phone number, social network ID, email address and IM handle.

The term “geographic location” (also “geo-location” and “geolocation” herein), as used herein, generally refers to the geographic location of an object, such as a user. A geolocation of a user can be determined or approximated using a geolocation device or system associated with the user, which may be an electronic device (e.g., mobile device) attached to or in proximity to the user. Geolocation information can include the geographic location of the object, such as coordinates of the object and/or an algorithm or methodology to approximate or otherwise calculate (or measure) the location of the object, and, in some cases, information as to other objects in proximity to the object. In some examples, geolocation information of a user includes the user's geographic location and/or the location of one or more other users in proximity to the user. Geolocation information can include the relative positioning between objects, such as between users. In some cases, the geolocation of an object (e.g., user or electronic device) is not necessarily the location of the object, but rather the location that the object enters an area or structure, such as a building.

In some cases, the geolocation of an object can be determined using the manner in which a mobile device associated with the object communicates with a communication node, such as a wireless node. In an example, the geolocation of an object can be determined using node triangulation, such as, e.g., wireless node (e.g., wireless beacon), WiFi node, satellite triangulation, and/or cellular tower node triangulation. In another example, the geolocation of an object can be determined by assessing the proximity of the object to a WiFi hotspot or one or more wireless routers. In some cases, the geolocation of an object can be determined using a geolocation device that includes a global positioning system (“GPS”), such a GPS subsystem (or module) associated with a mobile device (e.g., GPS capabilities of an Apple® iPhone® or Android® based system). The geolocation of an object can be determined with the aid of visual and/or audio information captured by an electronic device of a user, such as, for example, images and/or video captured by a camera of the electronic device, or a peripheral device (e.g., Google® Glass, Oculus® Rift, etc.) coupled to the electronic device.

The term “mobile device,” as used herein, generally refers to any portable electronic device that is configured to store contact information and/or present contact information to a user. A mobile device can be a portable electronic device, such as a portable personal computer (PC), slate or tablet PC's (e.g., Apple® iPad, Samsung® Galaxy Tab), telephones, Smart phones (e.g., Apple® iPhone, Android-enabled device, Blackberry®), personal digital assistants, smart watches or smart glasses (e.g., Google® Glass). A mobile device can include one or more sensors for sensing for sensing or otherwise detecting environmental, ambient and/or geolocation information of or associated with a user, or an environment of the user.

The term “accelerometer,” as used herein, generally refers to a device that measures proper acceleration (“g-force”). An accelerometer can be a component of an inertial navigation system.

The present disclosure provides methods and systems for enabling mobile electronic devices (also “mobile devices” herein) to exchange information, such as contact information. The exchange of information can be initiated upon a mobile electronic device (also “mobile device” herein) detecting an exchange event. In such a case, information can be exchanged immediately or at a later point in time. In examples, the information that is exchanged between mobile devices may include contact information.

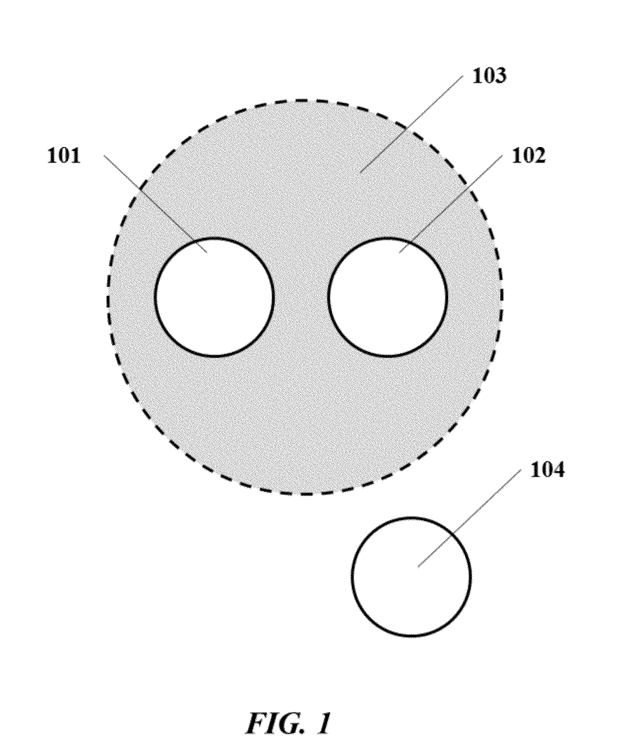

FIG. 1 schematically illustrates a system in which a first mobile device 101 and second mobile device 102 are within an area 103. The size of the area 103 can be selected such that the first mobile device 101 and second mobile device 102 can exchange contact information, location, photos, and other packets of information with one another either directly or indirectly through an intermediary device, such as a computer server, upon the occurrence and detection of an exchange event. In examples, each mobile device of two or more mobile devices may include a universally unique identifier (UUID). When an exchange event occurs between mobile devices, the exchange event may connect two or more UUIDs of the mobile devices within an application so as to enable communication between the mobile devices within the application. If the UUIDs include contact information, some or all of the contact information within the UUIDs may be exchanged between the mobile devices.

In some examples, a third mobile device 104 that is not in the area 103 may not be able or permitted to exchange contact information with the first mobile device 101 and second mobile device 102, but may be able to see limited information about the identities of 101 and 102 (e.g. the profile photo and first name of the user) and may be later added manually by a user in the exchange event.

Although two mobile devices 101 and 102 are shown in the area 103, more than two mobile devices may be in the area 103. In such a case, more than two mobile devices can exchange information, such as contact information, with one another in the area 103 upon the occurrence and detection of an exchange event. Additionally, in some examples a user of a mobile device may be notified when one or more users are within an area. The notification may be provided to the mobile device of the user. Further, in some examples the notification may be server driven. In other examples, the notification may be locally triggered on the device.

An exchange event can be a physical bump with another object, such as another mobile device, or a tap on the mobile device. In other examples, an exchange event may be initiated by a mobile device coming within a predetermined proximity of one or more other mobile devices. An exchange event may involve a pattern of movement between one or more mobile devices, where the pattern of movement may or may not involve physical contact between the one or more mobile devices. In some examples, an exchange event may include and/or be initiated by physically knocking two or more mobile devices together. In some examples, an exchange event may be initiated without physical contact between mobile devices occurring. In some examples, an exchange event may occur without physical contact between the mobile devices that are part of the exchange event. In examples, exchange of contacts is initiated when accelerometers detect movement or acceleration of a certain signature. In some examples, the exchange event is a pattern of at least 2, 3, 4, 5, 6, 7, 8, 9, or 10 taps (or bumps) on the mobile device, or a pattern of taps and pauses, or multiple patterns of taps, or other motion that is determined to be indicative of a user's willingness to initiate the exchange of contact information with one or more other users. The pattern can be predefined or manually set by a user of each mobile device.

In example, upon detecting an exchange event, each of the mobile devices involved in the exchange event may transmit identity information such that the other devices involved in the exchange event may receive the transmitted identity information. The system may then automatically also exchange contact information. In some examples, the system may exchange contact information based on a user's option, as discussed above with respect to FIG. 1. For example, a user may choose to allow contact information to be exchanged between two mobile devices, such as mobile devices 101 and 102, and may choose to not allow contact information to be exchanged between another mobile device, such as mobile device 104. Upon detecting the exchange event, the mobile device can exchange contact information with one or more other mobile devices either instantly or at a later point in time, such as at least 1 second, 30 seconds, 1 minute, 30 minutes, 1 hours, 2 hours, 3 hours, 4 hours, 5 hours, 6 hours, 12 hours, 1 day, 2 days, 3 days, 4 days, 5 days, 6 days, or 7 days later. The exchange of contact information can be directly with the one or more other mobile devices, or indirectly through a computer server.

The exchange event can be detected by the mobile device while the mobile device is held by the user or not held by the user. The exchange event can be detected while the mobile device is in a hand of the user, a pocket of the user, or not held by the user, such as while the mobile device is in a pocket of the user or a stationary (e.g., desk) or mobile object.

A mobile device can include one or more sensors for detecting an exchange event. A sensor can be a bump sensor, such as, for example, an accelerometer or a sensor that is capable of detecting vector acceleration, such as along three orthogonal x, y and z axes. The accelerometer can be a microelectromechanical (MEMS) accelerometer. The sensor can be a piezoelectric sensor. A sensor can be capable of sensing scalar or vector characteristics of motion and/or acceleration.

In some cases, an exchange of information is initiated only upon the occurrence and detection of the exchange event on all mobile devices that are involved in the exchange event. For example, if a first mobile device of a first user and second mobile device of a second user are to exchange user contact information with one another, the exchange of contact information is initiated upon the occurrence and detection of the exchange event (e.g., two knocks) on each of the first and second mobile devices. In an example, the first user can knock or tap twice on the first mobile device and the second user can knock or tap twice on the second mobile device to initiate the exchange of contact information. In such a case, contact information of the first user can be directly or indirectly transmitted from the first mobile device to the second mobile device, and contact information of the second user can be directly or indirectly transmitted from the second mobile device to the first mobile device. The type of contact information transmitted from the first mobile device to the second mobile device can be the same as or different than the type of contact information transmitted from the second mobile device to the first mobile device.

An exchange event can be indicative of the willingness of a user to share or initiate the sharing of contact information with one or more other users. The exchange event can be differentiated from other input detected by the mobile device (e.g., differentiated from general motion of the user), such as input associated with placing the mobile device on a table. In some examples, a machine learning algorithm can be employed to determine the exchange event and differentiate the exchange event from other input.

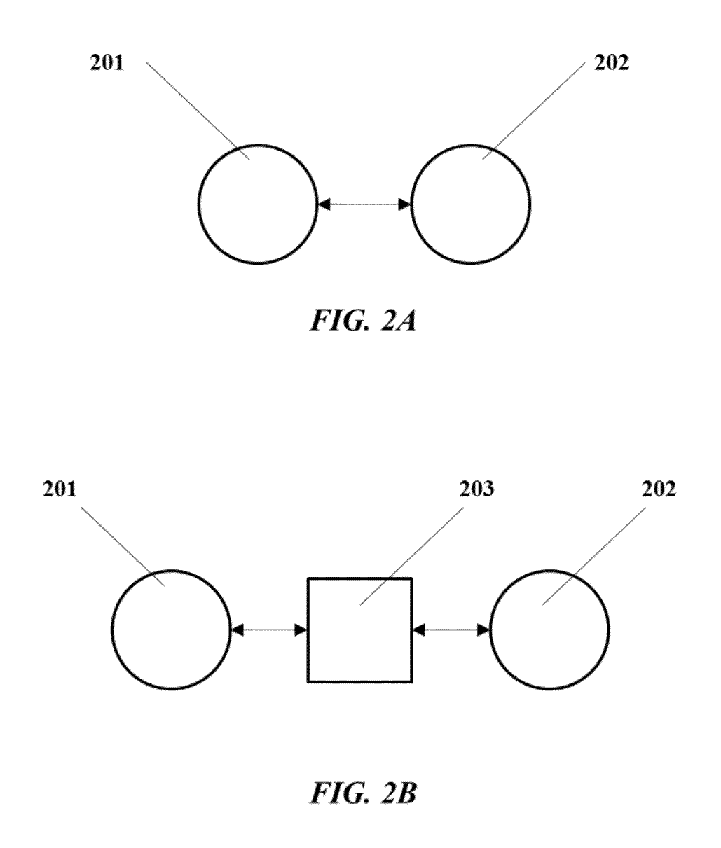

FIG. 2A schematically illustrates the exchange of data, including contact information, photos, and other identifying information, between a first mobile device 201 and a second mobile device 202 directly without the use of an intermediary electronic device. In such a case, upon the occurrence and detection of an exchange event by the mobile devices 201 and 202, information is transmitted from the first mobile device 201 directly to the second mobile device 202, and information is transmitted from the second mobile device 202 directly to the first mobile device 201. Data between the mobile devices 201 and 202 can be exchanged directly if the mobile devices 201 and 202 are in communication with one another, such as through a near-field communication (NFC) protocol, Bluetooth, or a wireless (e.g., WiFi) network. As an alternative, FIG. 2B schematically illustrates the exchange of data between the first mobile device 201 and the second mobile device 202 indirectly through an intermediary electronic device 203. The intermediary electronic device 203 can be a computer server.

The occurrence and detection of an exchange event and the transfer of contact information can be facilitated using a contacts application (“app”) executed on a mobile device of a user. The contacts app can securely exchange contact information, including identity information with identity attributes, and save such contact information in a contact database of the mobile device. The identify information may not include any identifying information of the user—for example, the identity information may be a media access control (MAC) address. The identity information and/or the contact information transmitted from the mobile device may be encrypted.

Contact information exchanged from one mobile device to another mobile device (e.g., either directly or indirectly through an intermediary computer server) can be selected by each user. For example, one user may wish to only exchange a name and telephone number with another user, while another user may wish to exchange all contact information with another user.

In an example, two users in proximity to one another can tap their mobile devices twice to indicate an exchange event. The contacts apps on their mobile devices can detect the exchange event and record a timestamp (e.g., date and time) and geolocation of the exchange event without exchanging any contact information. At a later point in time, the contacts apps can present the users with the option to exchange contact information with each other and allows each user to select which contact information to transmit to the other users. Next, contact information is exchanged either directly between the mobile devices or indirectly through a computer server.

A mobile device can monitor for an exchange event in the background or foreground. The exchange event can be monitored by the contacts app in the background or foreground, or by an operating system of the mobile device. In some cases, the exchange event can be monitored with the contacts app on the mobile device. The contacts app can also regulate the exchange of contact information with another mobile device, including the transmission of contact information to the other mobile device and receipt of contact information from other mobile devices. For example, the mobile device can monitor accelerometer signals to detect a pattern that is indicative of an exchange event (e.g., two knocks or bumps). This can be performed even when the mobile device is not being used by the user, such as, for example, when an electronic screen of the mobile device is locked or otherwise inactive.

Upon detecting the exchange event, the contacts app on the mobile device can collect and record contextual information, such as, for example, geolocation and local and/or ambient information. Contextual information can include, without limitation, geolocation, date, time, temperature, barometric pressure, humidity, weather, music, other nearby places, etc. This can enable the subsequent searching for users, such as searching for a date, time and geolocation in which the exchange event occurred. When the contacts app is subsequently accessed, the user can view other users that were captured during the exchange event and elect to share all or select contact information with the other users, request contact information from such other users, edit contact information on the mobile device of the user associated with such other users, or elect to not transmit any contact information to at least some of the other users. For example, in the exchange event the mobile device of a first user may have been in proximity to the mobile device of a second user and a mobile device of a third user. The first user may wish to only transmit contact information to the second user but not the third user. The first user may be presented with a list having the second user and third user, and may only elect the second user from the list.

Contextual information can be collected only if a user has permitted the mobile device to collect such contextual information. The user may permit the collection of contextual information by modifying settings of the contacts app executed on the mobile device, or through a gesture. The contextual information may be searchable by the user when looking for a given exchange event.

In some cases, upon the occurrence and detection of an exchange event by the mobile devices of at least two users that are in proximity to one another, the contacts app can begin the exchange of identity and contact information between the mobile devices. The identity information can be separate from the contact information. In some examples, the identity information is a unique identification number (UID) or any numerical and/or textual string that does not include identifying information of the user (e.g., name). This can be performed directly between the mobile devices, in some cases without any involvement from an intermediary computer server. As an alternative, identity data can be exchanged but contact information may not be exchanged until each user has verified that they wish to exchange contact information to the other user. In such a case, identity data can be exchanged directly between the mobile devices, but contact information can be exchanged later either between the mobile devices directly or indirectly through the computer server.

The exchange of contact information can be performed in a secure manner to help protect the privacy of a user and prevent contact information from reaching an unintended individual or being accessed by the unintended individual. In some cases, upon the occurrence and detection of an exchange event by the contacts app executed on a mobile device of the user, the contacts app can share an initial set of information, including identity information, with one or more other mobile devices. The initial set of information may not include any contact information of the user, but may include information that permits the subsequent identification of the user. When the user next opens the contacts app, the user can have the option to remove other users from the exchange event and/or share contact information (e.g. phone number and email address) or social media handles (e.g. Snapchat®, Facebook®, Instagram®, WhatsApp®) with at least a portion of the other users associated with the exchange event. This follow up data transfer of more private information can happen via a computer server or directly between the mobile device of the user and one or more other mobile devices that are in communication with the mobile device.

Information relevant to exchange events can be stored in tabular form, such as in a matrix. The matrix can include a date and/or time of an exchange event, geolocation of the exchange event, and user identity information, such as a universally unique identifier (UUID).

In some cases, the exchange of contact information can be asymmetric. For example, a first user can transmit contact information to a second user without receiving any contact information from the second user. As another example, the first user and second user can exchange different types of contact information. For instance, the first user can transmit a name and email of the first user to the second user, and the second user can transmit a name and phone number to the first user.

In some cases, a user can initiate the discovery of one or more other users by a mobile device of the user in a given area using an exchange event. For example, the user can tap the mobile device to initiate the discovery of the one or more other users. Once detected, the user may elect to share contact information with at least a subset of the one or more other users, or to request contact information from at least a subset of the one or more other users.

The system can provide a user the ability to discover all shared connections with a potential contact across various contexts (e.g., shared friends, colleges, employers, locations, etc.) via a reverse lookup (by phone number or email) to match a contact to identifying information (e.g. name, social profile photo, occupation, etc.), and then identifying a path to the user (provided there is a strong connection pathway to that potential contact).

The system can determine the relational strength between a user and a potential contact based on observed interactions between the user and shared connections with the potential contact (e.g., email interaction, social network interaction, etc.), as well as the strength of a relationship based on past shared experiences (e.g., locations, colleges, or work), shared interests, shared contacts, the structure of the network connecting the contacts and other information. This relational strength and other contextual information may be used to order contact lists by the relative probability that a user would want to contact a particular individual or invite them into a group chat.

### User Interfaces

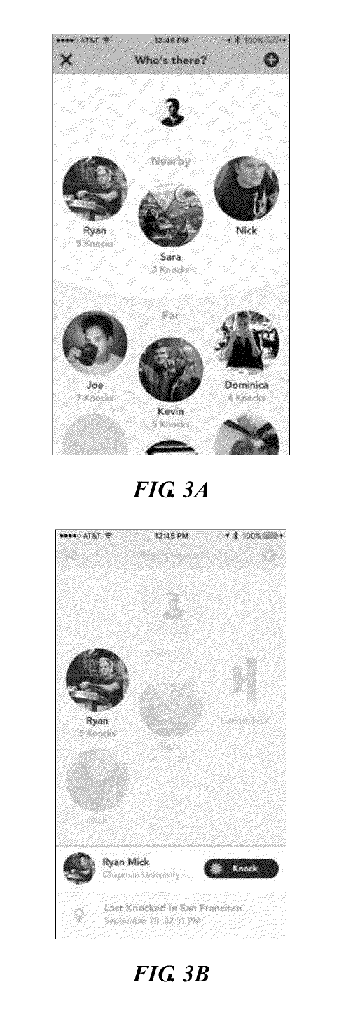

FIG. 3A shows an interface presented to a user showing nearby users sorted by physical distance and relevance. Physical distance may be estimated by GPS or by the signal strength of BLE, NFC, or Wi-Fi and relevance may order nearby contacts by relational strength. In example, the device may automatically look for any nearby active devices. In other examples, the user may also manually enter the information of an individual if they do not have an active device.

FIG. 3B shows an interface presented to a user after tapping on the profile photo of a nearby user. The interface displays biographical details about the nearby user, including shared connections and most recent meetings.

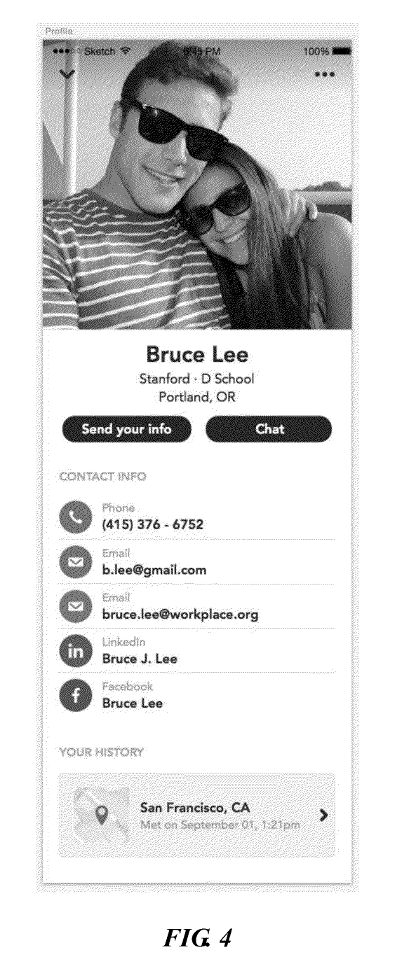

FIG. 4 shows an interface presented to a user after opening the full profile of a contact. This can provide users with comprehensive profiles for each contact. These may contain details about their education and work history, contact information and social media handles, mutually shared friends, mutually shared interests, and a unified interaction history.

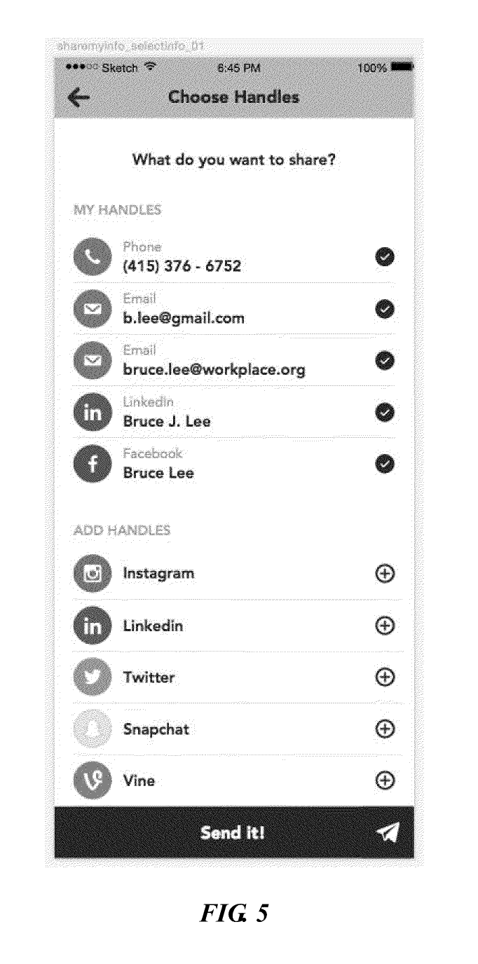

FIG. 5 shows an interface presented to a user after selecting to send contact information to an individual or group. As seen in FIG. 5, a user may select or deselect different types of contact information before sending the contact information to another user.

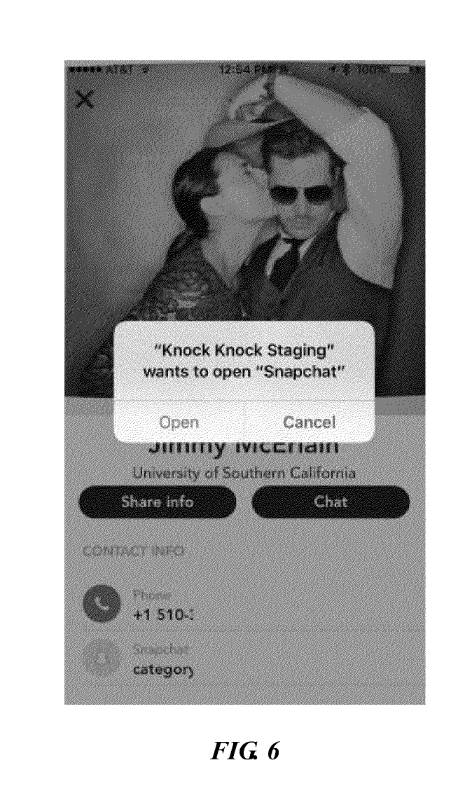

FIG. 6 shows an interface presented to a user after tapping on a piece of contact information in the profile of another user. The system will open the relevant third party application (e.g. Snapchat®, Facebook®, Instagram®, WhatsApp®) to open the connected profile of the contact, send a message, or make a call.

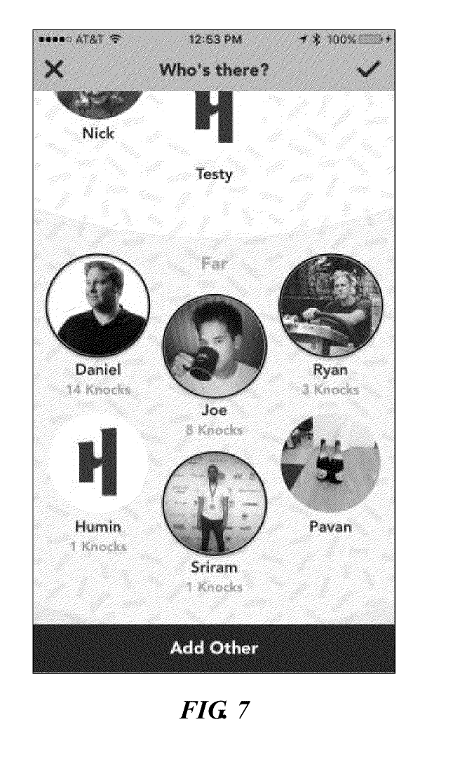

FIG. 7 shows an interface a user may use to quickly initiate a group chat with a subset of nearby users. In particular, a user may select a group by engaging an icon of each desired member of the group. If a desired contact is not in the nearby view, that user can be manually added to the group as well.

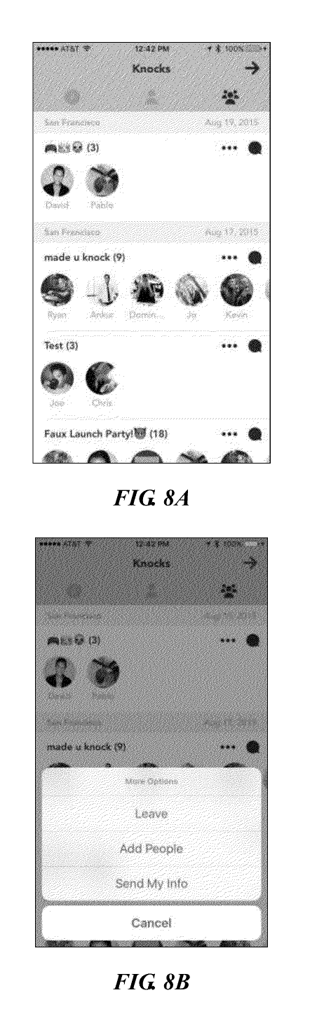

The system will allow users to store and easily navigate their exchange event and group-messaging history for later reference. FIG. 8A shows one example of a user interface detailing their event history in reverse chronological order.

FIG. 8B shows an interface a user may use to add members to a group, share contact information to all the members of a group, or leave a group directly from their event history.

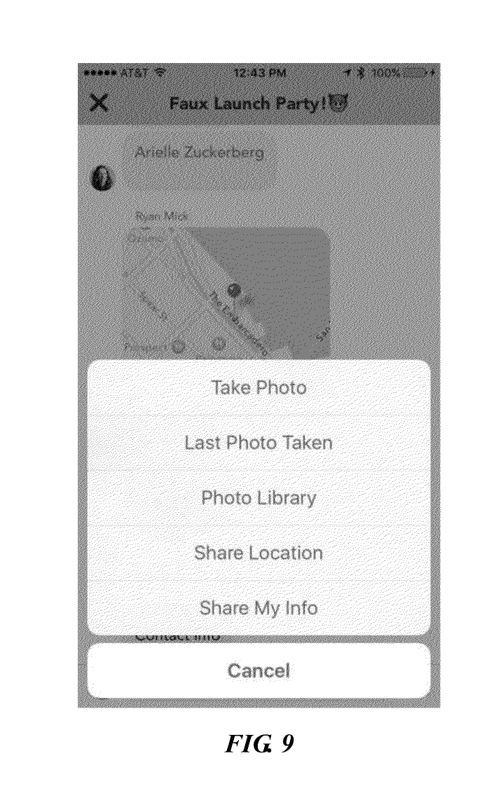

After an event is captured, the user may initiate a group-messaging feature to communicate with all of the users captured in a particular exchange event. FIG. 9 shows an example of a group chat interface that may be presented to a user. Users may send photos, share contact information, send their location, or other data to multiple users using the group-messaging feature.

### Algorithms

Systems of the present disclosure can implement various algorithms for contact management. Such algorithms can be implemented by way of software stored in a memory location, which can be executed by a computer processor.

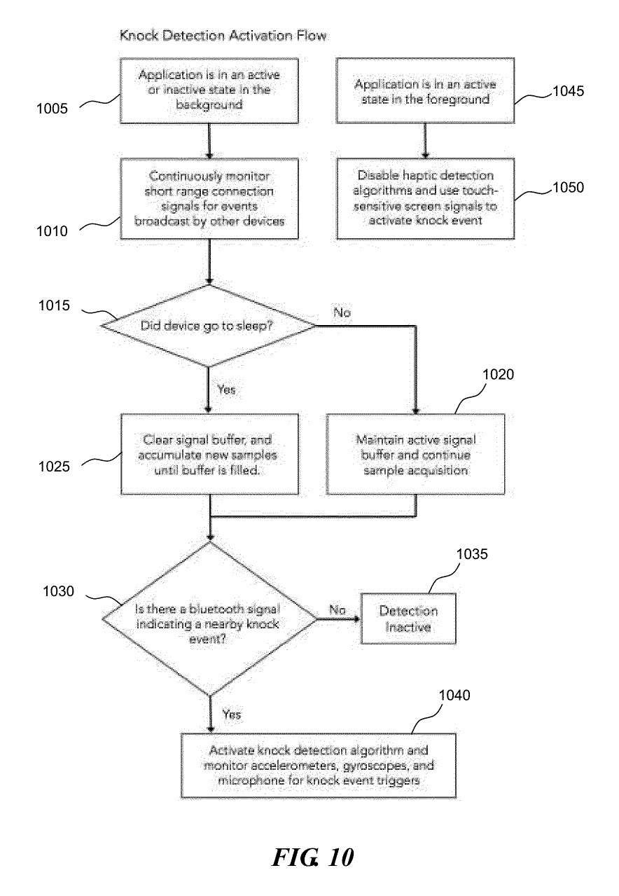

FIG. 10 shows an algorithm implemented by the system to determine whether or not to engage active monitoring of sensors in the device of a user. As seen in FIG. 10, at block 1005 an application is in an active or inactive state in the background. At block 1010, short range connection signals are continuously monitored for events broadcast by other devices. At decision point 1015, a determination is made as to whether a device has gone to sleep. If a device has gone to sleep, at block 1020 a clear signal is buffered and new samples are accumulated until the buffer is filled. If a device has not gone to sleep, at block 1025 an active signal buffer is maintained and sample acquisition is continued. At decision point 1030, a determination is made as to whether there is a Bluetooth signal indicating a nearby knock event. In examples, a knock event may be indicated by another signal, such as a near field communication (NFC), WiFi, global positioning signal (GPS) signal. A knock event may comprise an exchange event as discussed above. If there is not a Bluetooth signal indicating a nearby knock event, at block 1035 detection is inactive. If there is a Bluetooth signal indicating a nearby knock event, at block 1040 a knock detection algorithm is activated and accelerometers, gyroscopes, and microphones are monitored for knock event triggers. Additionally, at block 1045, if an application is in an active state in the foreground, a process may proceed to block 1050 so as to disable haptic detection algorithms and use touch-sensitive screen signals to active a knock event.

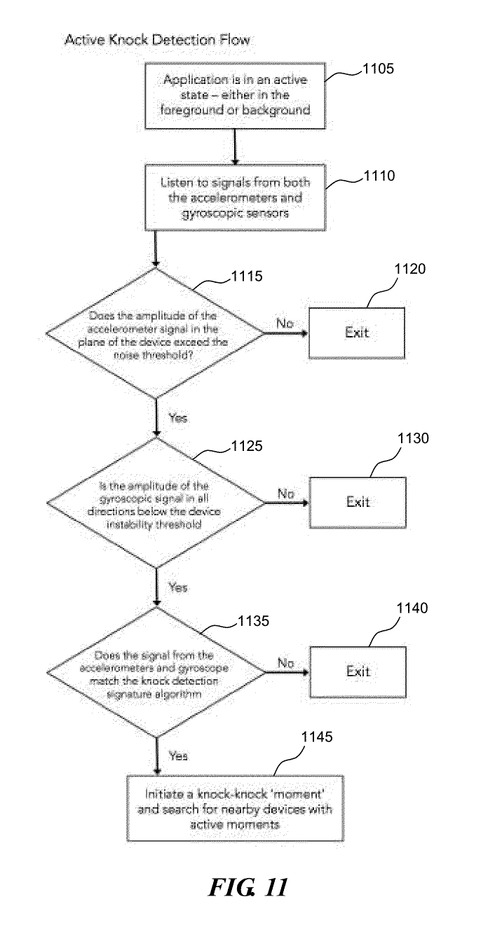

FIG. 11 shows an algorithm implemented by the system to detect specific haptic input, ‘knocks’, and determine if they meet the criteria to activate functionality within the application. At block 1105, an application is in an active state. In some examples the application is in an active state in the foreground. In some examples the application is in an active state in the background. At block 1110, signals from both accelerometers and gyroscopic sensors are listened to by the application. At decision point 1115, it is determined whether the amplitude of the accelerometer signal in the plane of the device exceeds the noise threshold. If not, the application exits knock detection mode at block 1120. If yes, the application moves to decision point 1125 where it is determined whether the amplitude of the gyroscopic signal in all directions is below the device instability threshold. If not, the application exits knock detection mode at block 1130. If yes, the application moves to decision point 1135 where it is determined whether the signal from the accelerometers and gyroscope match the knock detection signature algorithm. If not, the application exits knock detection mode at block 1140. If yes, a knock-knock “moment” is initiated and a search for nearby devices with active moments is activated at block 1145. In examples, a knock-knock “moment” may indicate an initiation of an exchange event or group chat.

### Computer Systems

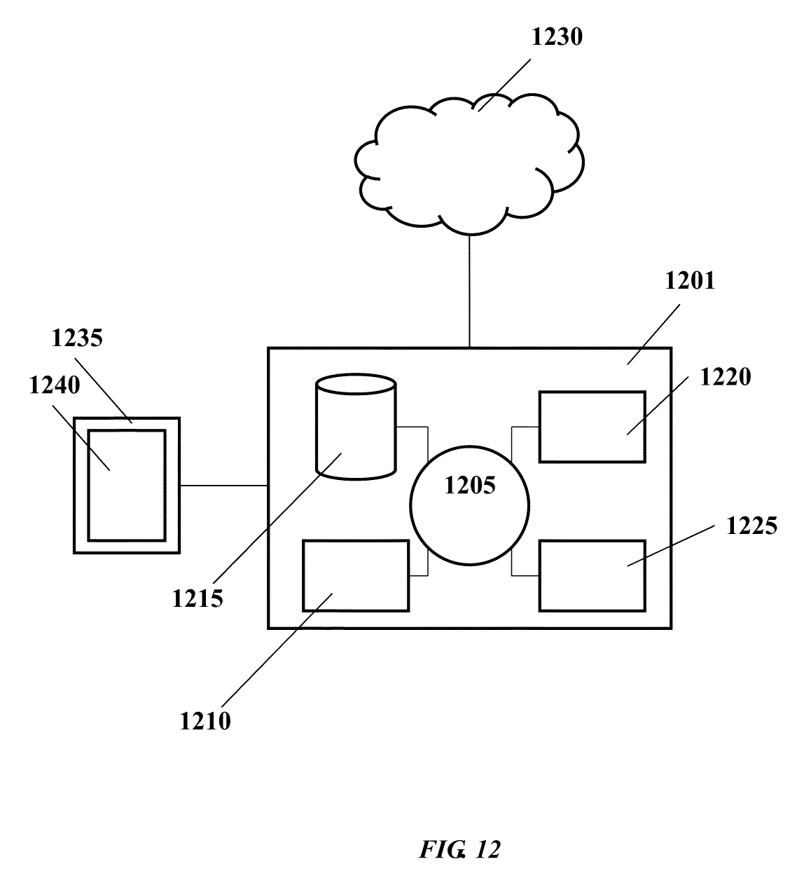

Methods of the present disclosure can be implemented on programmed computer systems. FIG. 12 shows a computer system 1201 that is programmed or otherwise configured to manage the exchange of contact information, including the transmission and receipt of contact information. The computer system 1201 can regulate various aspects of contact management of the present disclosure, such as, for example, detecting an exchange event and capturing contextual information. The contact database may be maintained on an electronic device of a user, or the computer system 1201.

The computer system 1201 can be a mobile (or wireless) device. As an alternative, the computer system 1201 can be a computer server that is in communication with the mobile device.

The computer system 1201 includes a central processing unit (CPU, also “processor” and “computer processor” herein) 1205, which can be a single core or multi core processor, or a plurality of processors for parallel processing. The computer system 1201 can be an individual server or multiple servers. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an intranet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. Examples of operations performed by the CPU 1205 can include fetch, decode, execute, and writeback.

The storage unit 1215 can store files, such as drivers, libraries and saved programs. The storage unit 1215 can store programs generated by users and recorded sessions, as well as output(s) associated with the programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems 1235 through the network 1230. For instance, the computer system 1201 can communicate with a remote computer system of a user, such as a user having a contact database with one or more contacts. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine have a processor adapted to execute the code, or can be compiled during runtime. The code can be supplied in a programming language that can be selected to enable the code to execute in a pre-compiled or as-compiled fashion.

In some cases, the computer system 1201 is a mobile device. The mobile device can include one or more sensors, such as for detecting an exchange event. The mobile device can further include a geolocation device, such as Global Positioning System (GPS) or wireless interface, such as WiFi or Bluetooth (e.g., for wireless triangulation or beacon detection). The mobile device can further include at least one input/output port, a power supply, a satellite navigation system receiver, such as a Global Positioning System (GPS) receiver, an accelerometer, a gyroscope, and/or a physical connector, which can be a USB port, IEEE 1394 (FireWire) port, and/or RS-232 port.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display that comprises a user interface (UI) for providing, for example, contacts. Examples of UI's include, without limitation, a graphical user interface (GUI) and web-based user interface. The UI can display the contact information of a user in addition to other contact information of one or more other users. The other contact information may have been retrieved as part of an exchange of contact information.

The UI can provide various features and functionalities. For example, the UI can have a layout and/or graphical elements that facilitate the presentation of identifying information of the one or more other users, as well as meeting particulars, including event name, geolocation, date and time. This can be implemented for any type of meeting between the user and the one or more other users, including ad-hoc meetings. As another example, the UI can have a layout and/or graphical elements for later viewing identifying information (e.g., name) of the one or more other users and requesting contact information from the one or more other users. The layout and/or graphical elements can be tailored to enable the sharing of contact information.

The computer system 1201 can include an application (“app”) that upon execution implements the methods provided herein. The app can be software that upon execution by one or more computer processors of the computer system 1201 facilitates the detection of an exchange event and the exchange of contact information. The computer system 1201 can include one or more data structures to facilitate the detection of an exchange event and the exchange of contact information. The app can also include networking code for discovery of users within a given area, such as using low power protocols, and networking code for sharing identification securely only to people within a certain area.

While methods and systems of the present disclosure have been described by way of mobile electronic devices, it will be appreciated that methods of the present disclosure may be employed for use with immobile electronic devices (also “immobile device” herein), such as desktop PC's. For example, the exchange of contact information may be made between a mobile device and an immobile device.

Methods and systems described herein may be combined with or modified by other methods and systems, such as those described in U.S. Patent Publication No. 2014/0148094, which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for contact management, comprising
(a) detecting a first exchange event on a first mobile electronic device of a first user, wherein said first exchange event is indicative of willingness of said first user to share a first contact information with one or more other users;
(b) initiating exchange of contact information between said first mobile electronic device and a second mobile electronic device of another user, wherein said second mobile electronic device has detected a second exchange event on said second mobile electronic device by said second user, wherein said second exchange event is indicative of willingness of said second user to share a second contact information with one or more other users;
(c) transmitting said first contact information from said first mobile electronic device to said second mobile electronic device; and
(d) receiving said second contact information of said second user at said first mobile electronic device.

2. The method of claim 1, wherein each of said first or second exchange event comprises a series of two or more taps on said first mobile electronic device and/or said second mobile electronic device.

3. The method of claim 1, wherein said first contact information is transmitted to said second mobile electronic device through a computer server.

4. The method of claim 1, further comprising:
receiving a notification of said one or more other users at or in proximity to said first mobile electronic device of said first user.

5. The method of claim 4, wherein said one or more other users comprise a plurality of users.

6. The method of claim 4, wherein each user of said plurality of users is within a threshold geographic distance from said first mobile electronic device of said first user.

7. The method of claim 5, further comprising:
initiating exchange of contact information between said first mobile electronic device and mobile electronic devices of said plurality of users, wherein each mobile electronic device of said plurality of mobile electronic devices has detected an exchange event on said mobile electronic device by a user of said plurality of users that is indicative of willingness of said user to share contact information with at least said first user.

8. The method of claim 7, further comprising:
transmitting said first contact information from said first mobile electronic device to said plurality of mobile electronic devices.

9. The method of claim 8, further comprising:
receiving said contact information of said plurality of users at said first mobile electronic device.

10. The method of claim 1, further comprising determining a relational strength between said first user and at least one user of said one or more other users.

11. The method of claim 1, wherein said first contact information and said second contact information contain at least one shared type of contact information.

12. The method of claim 1, wherein said first contact information and said second contact information contain different types of contact information.

13. The method of claim 1, further comprising transmitting additional information from said first mobile electronic device to said second mobile electronic device.

14. The method of claim 13, wherein said additional information comprises at least one of location information and photo information.

15. A system for contact management, comprising:
a communications interface that brings a first mobile electronic device of a first user in communication with a second mobile electronic device of a second user; and
one or more computer processors operatively coupled to said communications interface, wherein said one or more computer processors are programmed to:
(a) detect a first exchange event on a first mobile electronic device of a first user, wherein said first exchange event is indicative of willingness of said first user to share a first contact information with one or more other users;
(b) initiate exchange of contact information between said first mobile electronic device and a second mobile electronic device of another user, wherein said second mobile electronic device has detected a second exchange event on said second mobile electronic device by said second user, wherein said second exchange event is indicative of willingness of said second user to share a second contact information with one or more other users;
(c) transmit said first contact information from said first mobile electronic device to said second mobile electronic device; and
(d) receive said second contact information of said second user at said first mobile electronic device.

16. The system of claim 15, wherein said one or more computer processors are programmed to transmit additional information from said first mobile electronic device to said second mobile electronic device.

17. The system of claim 16, wherein said additional information comprises at least one of location information and photo information.

18. The system of claim 15, wherein said one or more computer processors are programmed to initiate said exchange of contact information between said first mobile electronic device and a plurality of mobile electronic devices that are each associated with an unique user.

19. The system of claim 15, wherein said one or more computer processors are programmed to receive a notification of said one or more other users, which one or more other users are at or in proximity to said first mobile electronic device of said first user.

20. The system of claim 15, wherein said one or more computer processors are programmed to determine a relational strength between said first user and at least one user of said one or more other users.

21. A non-transitory computer readable medium comprising machine-executable code that, upon execution by one or more computer processors, implements a method for contact management, the method comprising:
(a) detecting a first exchange event on a first mobile electronic device of a first user, wherein said first exchange event is indicative of willingness of said first user to share a first contact information with one or more other users;
(b) initiating exchange of contact information between said first mobile electronic device and a second mobile electronic device of another user, wherein said second mobile electronic device has detected a second exchange event on said second mobile electronic device by said second user, wherein said second exchange event is indicative of willingness of said second user to share a second contact information with one or more other users;
(c) transmitting said first contact information from said first mobile electronic device to said second mobile electronic device; and
(d) receiving said second contact information of said second user at said first mobile electronic device.

22. The method of claim 1, wherein said detecting a first exchange event on a first mobile electronic device of a first user comprises analyzing sensory signals of the first mobile electronic device to determine that an engagement event has occurred.
